(19) United States
(12) Patent Application Publication
(10) Pub. No.: US 2006/0096153 A1
(43) Pub. Date: May 11, 2006

(54) Flexible segment fishing pole

(76) Inventor: Man Young Jung, Pasadena, CA (US)

Correspondence Address: LAW OFFICES OF CLEMENT CHENG, 17220 NEWHOPE STREET #127, FOUNTAIN VALLEY, CA, 92708, US

(21) Appl. No.: 10/985,675

(22) Filed: Nov. 11, 2004

(51) Int. Cl. A01K 87/00

(52) U.S. Cl. 43/18.1 R

(57) ABSTRACT

An improvement to a fishing pole is disclosed, the improvement including a flexible segment that separates a resilient rod of the fishing pole into lower and upper portions. Both the upper and lower portions are interconnected through the flexible segment. A rigid retractable sleeve is positionable in either a disengaged position away from the flexible segment or in an engaged position over the flexible segment. In the disengaged position, the sleeve is positioned so that it covers part of the lower section of the rod, but none of the flexible segment, thereby allowing the flexible segment to flex more freely during casting, for example. In its engaged position, however, the sleeve is positioned to cover the flexible segment completely, interconnecting in a rigid fashion the upper portion of the rod to the lower portion of the rod. As Such, the upper portion pivotably fixed with respect to the lower portion, and is thereby made more characteristic of a conventional fishing pole.

### FIELD OF THE INVENTION

The present invention relates generally to fishing poles, and, more particularly is directed towards a fishing pole with flexible segment for greater casting distances.

### DISCUSSION OF RELATED ART

Prior art fishing poles have been developed to increase the distance that a fisherman can cast a fishing lure. A longer cast results in a longer time in the water for the fishing lure, per cast, thereby increasing the odds that a fish will be attracted to the lure and will bite. Moreover, a longer cast results in less competition for fish in waters where other fisherman cannot cast, thereby increasing the odds that a fisherman who can cast a greater distance will catch fish. Indeed, certain larger fish prefer deeper waters, and therefore the fisherman who can cast out to deeper water from, say, the edge of a lake or the end of a pier, has improved odds of catching such larger fish.

U.S. Pat. No. 4,656,773 to Klefbeck on Apr. 14, 1987 teaches an energy efficient casting rod. Such a device has a complicated set of pulleys and cabling, and as such is both somewhat difficult to use and maintain, and is considerably longer than an average fishing pole. As such, it may only be used in certain open locations where the threat of snagging another fisherman or bystander is low. Further, such a device is awkward to use due to its extended length.

Therefore, there is a need for an easy-to-use and easy-to-maintain fishing pole that can provide casts of greater distances to the average user. Such a needed fishing pole would include an improvement that could be readily built into the fishing pole upon its initial manufacture, or retrofitted onto an existing fishing pole. The present invention accomplishes these objectives.

### SUMMARY OF THE INVENTION

In a fishing rod that has a resilient rod, a handle, and a reel, an improvement includes a flexible segment that separates the resilient rod into lower and upper portions. Both the upper and lower portions are interconnected through the flexible segment, which is preferably a flexible spring or the like. A rigid retractable sleeve is positionable in either a disengaged position away from the flexible segment or in an engaged position over the flexible segment. In the disengaged position, the sleeve is positioned so that it covers part of the lower section of the rod, but none of the flexible segment, thereby allowing the flexible segment to flex more freely during casting, for example. In its engaged position, however, the sleeve is positioned to cover the flexible segment completely, interconnecting in a rigid fashion the upper portion of the rod to the lower portion of the rod. As such, the upper portion is not, free to pivot with respect to the lower portion, and as such is more characteristic of a conventional fishing pole.

In use, the user sets the sleeve in the disengaged position and casts the lure. The user may utilize the greater flexibility of the fishing rod to cast the lure a greater distance than he could without the increased flexibility of the rod, either by casting overhead or sideways. Once the lure has been cast, the user then positions the sleeve into the engaged position, greatly reducing the flexibility of the fishing rod and making it more suitable for use in setting a hook during a fish strike at the lure and then reeling in the catch.

The present invention may be easily retrofitted onto an existing fishing pole, or integrated into the manufacture of a new fishing pole. The present invention provides the user a choice between greater pole flexibility, which is useful to cast a lure a relatively great distance, and conventional pole flexibility for use after casting. The device is easy to use and easy to maintain. The present device is, moreover, relatively inexpensive to manufacture, and does not include complicated pulleys or excessive mechanisms that can be difficult to use and maintain. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a elevational illustration of the invention, illustrating a fishing pole having a flexible section and a rigid sleeve in a disengaged position; and

FIG. 2 is a partial elevational view, illustrating the sleeve of the invention in both the disengaged position and, alternately, in an engaged position.

### DETAILED DESCRIPTION OF THE PREFERRED EMBODIMENT

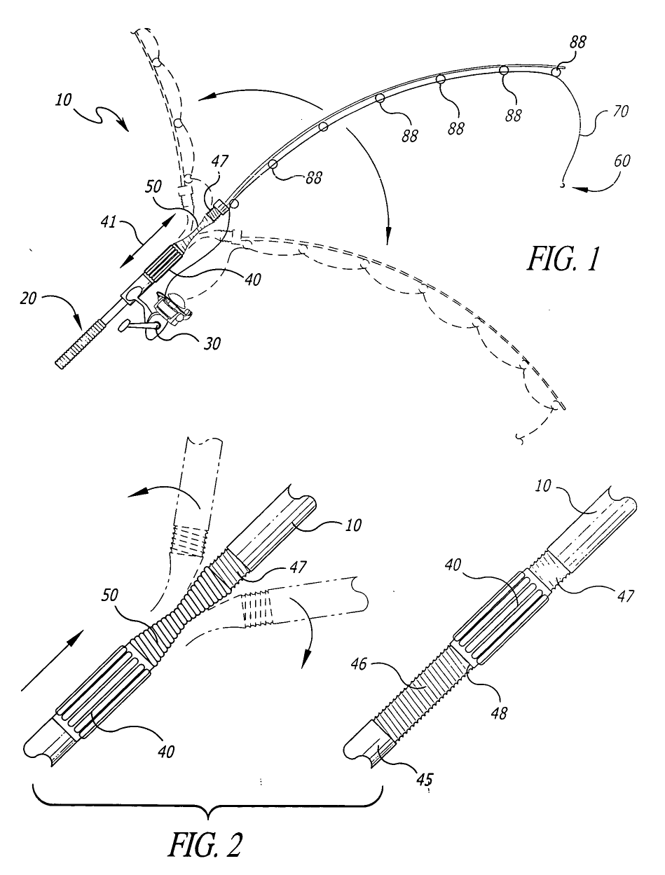

The present invention is an improved fishing rod 10 that has a resilient rod 15, a handle 20, and a reel 30 (FIG. 1). As with conventional fishing rods 10, a monofilament line 70 is threaded from the reel 30 through a plurality of eyelets 88 fixed to the resilient rod 15 and terminating at a lure or hook 60. The fishing rod 10 of the present invention is separated into a lower portion 18 and an upper portion 19, each portion 18,19 being interconnected through a flexible segment 50, such as a flexible spring (FIG. 2) or elastomeric member (not shown). The flexible segment can be a helical spring or a leaf spring. The flexible segment can be made of polymer, or metal.

The lower portion 18 and upper portion 19 may be fixed to the flexible segment 50 in a variety of ways known by those skilled in the art, such as by inserting the ends of each portion 18, 19 into a hollow cylindrical portion at each end of the flexible segment 50 and fixing the same in place with a plurality of set screws, for example (not shown). The preferred mode is to connect the upper portion and lower portion to the flexible segment by adhesive and binding structure such as a laminate or other commercially available means for connecting fishing rod components.

A rigid retractable sleeve 40 is positionable along a sliding path 41 in either a disengaged position or an engaged position (FIGS. 1 and 2). The sliding path is preferably straight but can also be curved. Where the retractable sleeve is arc shaped, the sliding path can also be arc shaped to accommodate the curved profile of the sleeve. The longitudinal axis of the sleeve 40 is co-aligned with the longitudinal axis of the resilient rod 15. In the disengaged position, the sleeve 40 is positioned so that it covers part of the lower section 18 of the rod 10 (FIG. 2), but none of the flexible segment 50, thereby allowing the flexible segment 50 to flex freely during casting, for example. The result is that the upper portion 19 of the fishing rod 10 may pivot back and forth a greater distance than with a prior art fishing rod. In its engaged position, however the sleeve 40 is positioned to cover the flexible segment 50 completely, interconnecting in a rigid fashion the upper portion 19 to the lower portion 18. As such, the upper portion 19 is not free to pivot freely with respect to the lower portion 18, and as such is more characteristic of a conventional fishing pole.

The basic principle is that the sleeve engages and disengages to allow the user a rigid or flexible pole. The sleeve fixedly engages to the upper portion of the fishing rod by a variety of connection means including magnetic, threaded as seen in FIG. 1 and FIG. 2, and slotted.

In the threaded model, the upper portion of the fishing rod and the lower portion of the fishing rod both have threads. The sleeve engages upon the threads because the sleeve interior is also threaded according to the same pitch. A user can simply turn the sleeve to engage the sleeve onto the upper portion. Similarly, if the sleeve is mounted above the flexible segment 50, the user simply turns the sleeve to engage the sleeve into the lower portion.

In the slotted model, the sleeve has one or more slots that engage with pins or protrusions mounted on the rod. Where the sleeve is mounted below the flexible segment 50 a user can pull the sleeve up and then fix the sleeve slot into the pin or protrusion shaped to receive the slot. Where the sleeve is mounted above the flexible segment 50 a user can pull the sleeve down and then fix the sleeve slot into the pin or protrusion shaped to receive the slot. The sleeve once engaged, provides support and reinforces the flexible segment 50 so that the flexible segment becomes a rigid segment.

In an alternate embodiment of the invention, the sleeve 40, in its disengaged position, covers part of the upper portion 19 and none of the flexible segment 50. In such an embodiment, however, the sleeve 40 must lockable in the disengaged position so that gravity or the forces resulting during casting of the fishing rod 10 do not cause the sleeve 40 to slide down over the flexible segment 50 when such is not desired.

While the sleeve 40 is the preferred mode of reinforcing the flexible segment 50, an alternate method is with a rigid rod (not shown) that slides between an engaged position that rigidly connects the upper portion of the rod with the lower portion of the rod, and a disengaged position. Such a rigid rod is parallel to the resilient rod 15, but is not co-aligned therewith. Such a rigid rod would have a protruding handle for easily sliding the rod into either the engaged or disengaged position.

A mounting means 45 for the sleeve 40 may include internal threads 48 on an inside surface of the sleeve 40 that engage lower portion threads 46 and upper portion threads 47 (FIG. 2), for example. As such, the sleeve 40 is spun around its longitudinal axis to assume either the engaged or disengaged position. In this preferred embodiment, tightening the sleeve 40 by rotating results in rotational friction holding the sleeve 40 in place in either the engaged or disengaged position.

Parallel grooves can take the place of the internal threads 48 such that the internal threads 48 allows little or no rotation of the sleeve 40 during retraction and engagement. Also, parallel grooves or internal threads 48 can be omitted.

In use, the user sets the sleeve 40 in the disengaged position and casts the lure. However, the user may utilize the greater flexibility of the fishing rod 10 to cast the lure 60 a greater distance than he could without the increased flexibility of the rod 10. Once the lure 60 has been cast, the user then positions the sleeve 40 into the engaged position, greatly reducing the flexibility of the fishing rod 10 and making it more suitable for use in setting a hook during a fish strike at the lure 60 and reeling in the catch.

An alternate mounting means 45 may be an annular ridge encircling one area of the lower portion 18 and another annular ridge encircling one area of the upper portion 19 (not shown), whereby annular grooves on the inside surface of the sleeve 40 engage the annular ridges and frictionally lock the sleeve 40 into the disengaged position or engaged position.

Yet another alternate mounting means 45 may be a magnetic catch in both the upper portion 19 or the lower portion 18 of the rod 10 (not shown), such that a sleeve 40 made from a rigid magnetically active metal or the like can be magnetically locked into either the engaged or disengaged position by slide such a sleeve 40 between positions manually.

Clearly, a wide variety of mounting means 45 may be incorporated into either new fishing rods 10 or retrofitted onto existing fishing rods 10. Moreover, a wide variety of flexible segments 50 may be utilized to accomplish the objectives of the present invention. For example, while a coiled spring is the preferred mode of the flexible segment 50, a rubber or other flexible elastomeric element or rod (not shown) may be used as the flexible segment 50. Further, the resilient rod 15 may be modified by cutting a plurality of grooves (not shown) into the rod 15, increasing the flexibility of the rod 15 in the portion with grooves. Thus, while a particular form of the invention has been illustrated and described, it will be apparent that various modifications can be made without departing from the spirit and scope of the invention. Accordingly, it is not intended that the invention be limited, except as by the appended claims.

1. In a fishing pole having a resilient rod, an improvement comprising:
a flexible segment separating and interconnecting a lower portion of the rod from an upper portion of the rod; and
a rigid retractable sleeve, the sleeve positionable in both an engaged position rigidly interconnecting the lower portion of the rod to the upper portion of the rod, thereby reinforcing the flexible segment, and a disengaged position fixed to the lower portion of the rod but not extending up over the flexible segment.

2. The fishing pole of claim 1 wherein the rod is made of fiberglass.

3. The fishing pole of claim 1 wherein the rod is made of wood.

4. The fishing pole of claim 1 wherein the rod is made of metal.

5. In a fishing pole having a resilient rod, an improvement comprising:
a flexible segment separating and interconnecting a lower portion of the rod from an upper portion of the rod,
a rigid retractable sleeve, the sleeve positionable in both an engaged position interconnecting the lower portion of the rod to the upper portion of the rod, thereby reinforcing the flexible segment, and a disengaged position attached to the upper portion of the rod but not extending down over the flexible segment.

6. The fishing pole of claim 1 further comprising a sleeve mounting having sleeve slots, and engaging pins mounted on the rod, whereby the sleeve moves between the engaged and the disengaged positions when the sleeve slots engage and disengage with the engaging pins.

7. The fishing pole of claim 1 further comprising a sleeve mounting having screw threads, whereby twisting the sleeve moves the sleeve between the engaged and the disengaged positions.

8. The fishing pole of claim 1 wherein the sleeve can be locked into either the engaged or disengaged position.

9. In a fishing pole having a resilient rod, an improvement comprising:
a flexible segment separating and interconnecting a lower portion of the rod from an upper portion of the rod,
a rigid retractable member, the retractable member positionable in both an engaged position interconnecting the lower portion of the rod to the upper portion of the rod, thereby reinforcing the flexible segment, and a disengaged position attached to the lower portion of the rod but not extending up over the flexible segment.

10. The fishing pole of claim 9 wherein the rigid retractable member is formed as a bar.

11. The fishing pole of claim 9 wherein the rigid retractable member is formed as a rod.

12. The fishing pole of claim 9 further comprising a retractable member mounting having screw threads, whereby twisting the retractable member moves the retractable member between the engaged and the disengaged positions.

13. The fishing pole of claim 9 wherein the retractable member is a rigid sleeve, and further comprising a sleeve mounting having sleeve slots, and engaging pins mounted on the rod, whereby the sleeve moves between the engaged and the disengaged positions when the sleeve slots engage and disengage with the engaging pins.
